(19) United States
(12) Patent Application Publication
(10) Pub. No.: US 2002/0024429 A1
(43) Pub. Date: Feb. 28, 2002

(54) Anti-theft system for a motor vehicle and method for operating the anti-theft system

(76) Inventor: Siegfried Kamlah, Braunschweig (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/940,092

(22) Filed: Aug. 27, 2001

(30) Foreign Application Priority Data
Aug. 25, 2000 (DE) 100 41 801.5

(51) Int. Cl. B60R 25/10

(52) U.S. Cl. 340/426; 340/10.1

(57) ABSTRACT

A vehicle-mounted transmitter emits an interrogation code signal in a wave having elliptical or circular polarization. A portable receiver evaluates the received signal only if it receives field components in at least two spatial directions. If the interrogation code signal is accepted by the receiver, a response code signal is transmitted back to the motor vehicle as proof of authorization.

### BACKGROUND OF THE INVENTION

### FIELD OF THE INVENTION

The invention relates to an anti-theft system for a motor vehicle and a method for operating an anti-theft system for a motor vehicle with which door locks can be locked or unlocked and an immobilizer released.

A known anti-theft system (see Published, Non-Prosecuted German Patent Application DE 195 42 441 A1) has a vehicle mounted transceiver unit, which emits an interrogation signal via antennas. If a portable code generator receives the interrogation signal, it automatically transmits back a coded response signal. The authorization of the response signal is evaluated in the transceiver unit, and if authorization is determined functions of the vehicle, for example locking or unlocking of door locks or triggering of an immobilizer, are controlled.

The antenna of the known anti-theft system is composed of two antenna coils which are located very close to one another and are actuated separately from one another and phase-shifted so that an electromagnetic field which moves spatially to and fro is produced. This is intended to ensure that the portable code transmitter reliably receives the interrogation signal, and does so independently of the direction of orientation of its antennas. That is to say the interrogation signal is to be received reliably irrespective of the direction of orientation in which the code transmitter is carried.

In a further known anti-theft system (see Published, Non-Prosecuted German Patent Application DE 197 18 423 A1), a portable code transmitter is used which has three antennas, which are each disposed perpendicularly with respect to one another. In this way, signals can be reliably received in the code transmitter irrespective of how the electromagnetic field was generated because the reception characteristics of the antennas are present in all three spatial directions. A single antenna, which emits a linearly polarized wave is therefore sufficient as the transmitter.

On the one hand, it is desired that the code transmitter reliably receives the signals of the vehicle-mounted transceiver unit. On the other hand, the dialog between the vehicle and the code transmitter is critical for security because authorization to access and use the vehicle is transmitted with the response signal. For this reason, the signals should be difficult for unauthorized third parties to monitor illegitimately, and it should also be difficult for them to be extended to a distant station for evaluation purposes and reproduced by the station.

### SUMMARY OF THE INVENTION

It is accordingly an object of the invention to provide an anti-theft system for a motor vehicle and a method for operating the anti-theft system which overcome the above-mentioned disadvantages of the prior art devices and methods of this general type, which provides a high degree of security against illegitimate monitoring and reproduction of signals.

With the foregoing and other objects in view there is provided, in accordance with the invention, an anti-theft system for a motor vehicle. The anti-theft system includes a vehicle-mounted transceiver unit for emitting an interrogation signal. The transceiver unit has an antenna unit emitting a wave having an elliptical polarization or a circular polarization and the wave includes the interrogation signal. A portable code transmitter transmits back a response signal if the code transmitter receives the interrogation signal. A vehicle-mounted evaluation unit receives and checks an authorization of the response signal and if the response signal provides proper authorization, the evaluation unit triggers or enables vehicle-specific functions.

Here, the wave has an elliptical polarization or a circular polarization and is emitted from the vehicle. In the wave, a coded information item is transmitted modulated as the interrogation signal. Equally, a further coded information item can be transmitted from the code transmitter to the motor vehicle in a response signal in a wave having the elliptical or circular polarization.

The code generator responds with its response signal only if it has itself received a wave having elliptical or circular polarization. Likewise, it is possible to provide for the vehicle-mounted transceiver unit to pass on the response signal for evaluation only if it has itself received a wave having elliptical or circular polarization and in addition the coded information item contained in the response signal corresponds to a desired code information item expected at the vehicle end.

In accordance with an added feature of the invention, the transceiver unit and/or the code transmitter have at least two antennas disposed approximately perpendicularly to one another and are controlled phase-shifted with respect to one another for a transmission of signals in order to generate the wave.

In accordance with another feature of the invention, the vehicle-specific functions include a locking of locks, an unlocking of the locks, a turning-off of an immobilizer, and a turning-on of the immobilizer. The vehicle-specific functions are controlled by the response signal generated by the code transmitter.

With the foregoing and other objects in view there is provided, in accordance with the invention, a method for operating an anti-theft system. The method includes the steps of using a vehicle-mounted transceiver unit for emitting an interrogation signal provided in a wave having an elliptical polarization or a circular polarization; receiving the interrogation signal in a portable code transmitter; and transmitting back a response signal by the code transmitter only if at least two field components of the interrogation signal which are different in their spatial direction are received.

In accordance with a further mode of the invention, there is the step of generating the wave using two coils disposed perpendicularly with respect to one another. The two coils function as antennas and are actuated by a phase angle of less than/equal to 90° with respect to one another.

In accordance with another mode of the invention, there is the step of actuating one of the two antennas for at least a predetermined time period starting at a predetermined time with a modified transmission power.

With the foregoing and other objects in view there is further provided, in accordance with the invention, another method for operating an anti-theft system. The method includes the steps of receiving an interrogation signal in a portable code transmitter and a response signal is subsequently transmitted back as a wave having an elliptical polarization or a circular polarization; and recognizing the response signal as being authorized by a vehicle-mounted transceiver unit only if, at least two field components of the response signal which are different in their spatial direction are received and, a coded information item contained in the response signal corresponds to a coded information item expected by a vehicle-mounted evaluation unit.

Other features which are considered as characteristic for the invention are set forth in the appended claims.

Although the invention is illustrated and described herein as embodied in an anti-theft system for a motor vehicle and a method for operating the anti-theft system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of a vehicle-mounted transceiver unit according to the invention;

FIGS. 2A to 2C are illustrations of antennas of the transceiver unit according to FIG. 1;

FIG. 3 is a block circuit diagram of a portable code transmitter;

FIGS. 4A and 4B are signal diagrams of a binary coded interrogation signal, such as is fed to the vehicle-mounted antennas for emission; and

FIG. 5 is a perspective view of a configuration of antennas in the motor vehicle.

### DESCRIPTION OF THE PREFERRED EMBODIMENTS

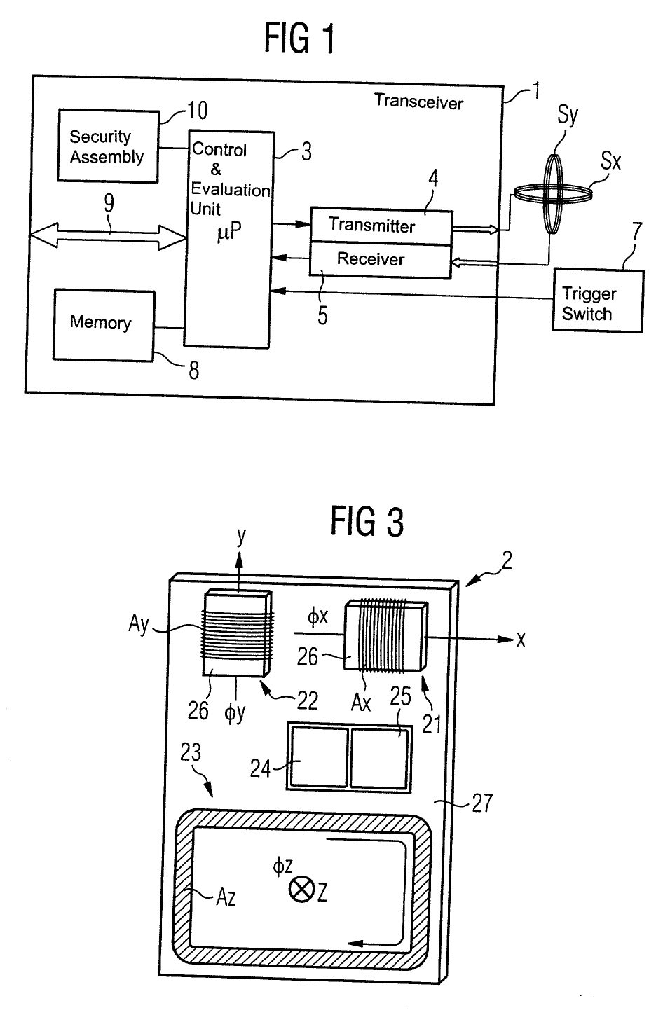

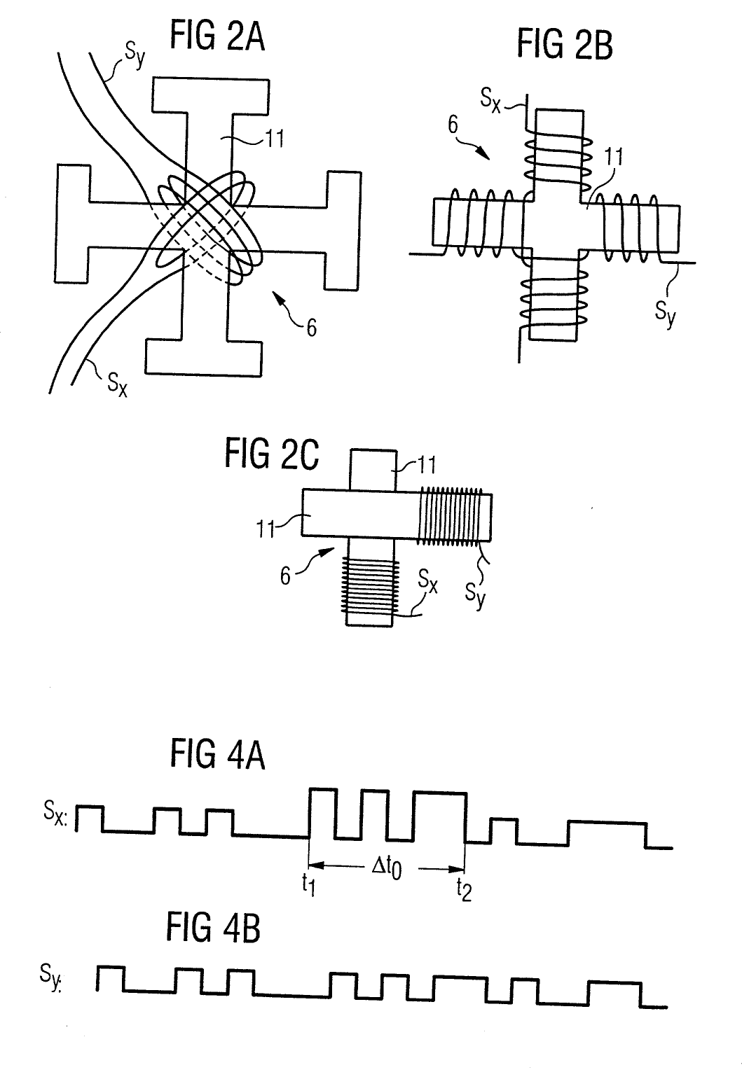

In all the figures of the drawing, sub-features and integral parts that correspond to one another bear the same reference symbol in each case. Referring now to the figures of the drawing in detail and first, particularly, to FIG. 1 thereof, there is shown an anti-theft system for a motor vehicle that has a vehicle-mounted transceiver unit 1. Interrogation signals are emitted in modulated form by the transceiver unit 1 and response signals are received from a portable code transmitter 2 (see FIG. 2). An authorization of the response signals is checked in the transceiver unit 1 and when authorization is present settings are made in the motor vehicle or security assemblies of the motor vehicle are controlled.

For this purpose, the transceiver unit 1 has a central control and evaluation unit 3, which controls a transmitter 4 and a receiver 5. The transmitter 4 and the receiver 5 are each connected to an antenna unit 6 with one or more individual antennas (coils in the exemplary embodiment). There may also be a common antenna unit which can both transmit and receive signals.

If a trigger switch 7, for example on a door handle of the motor vehicle, is activated, the transmitter 4 is instructed by the control and evaluation unit 3 to emit an interrogation signal. The control and evaluation unit 3 subsequently waits for a response signal. If the response signal is received by the transceiver unit 1, it is evaluated in the control and evaluation unit 3. A coded information item from the response signal, the item being transmitted by the code transmitter 2, is compared with a desired code information item that is expected in the motor vehicle and is stored in a desired value memory 8.

If the two coded information items correspond, one or more coded control signals are transmitted to electronic devices or security assemblies via a databus 9 in accordance with a control information item contained in the response signal. The security assemblies may be door locks, tailgate locks, immobilizers and the like. The control and evaluation unit 3 can be also be directly connected to security assemblies 10.

When correspondence occurs, further settings can also be made in the motor vehicle or functions of electronic equipment can be controlled using the code transmitter 2, it being possible, for example, to open and close windows, switch on the air conditioning system or the fan, open or close the folding top etc., or person-specific settings such as seat setting, mirror setting, radio transmitter etc., can be made.

According to the invention, the interrogation signal is emitted in a wave having circular or elliptical polarization. For this purpose, each antenna unit 6 has at least two individual antennas, which are disposed with their transmission characteristics spatially offset with respect to one another.

In motor vehicle technology, wire-free emission of signals is usually carried out at 125 kHz. At this frequency, coils are used as antennas. The signals can also be emitted at other, higher frequencies, which then requires appropriately configured antennas.

A wave having elliptical or circular polarization is composed of two waves with linear polarization in planes, which are perpendicular to one another. In a wave having circular polarization, the two linearly polarized waves are phase-shifted with respect to one another by 90°. In the case of the elliptically polarized wave, the phase angle is less than 90°. A wave having circular polarization is therefore a special case of an elliptically polarized wave. In order to be able to emit a wave having elliptical or circular polarization at 125 kHz, it is sufficient if—in the exemplary embodiment—two coils Sᵢ are disposed perpendicularly with respect to one another and at the same location.

So that a wave having elliptical or circular polarization can be generated in the low-frequency range (at approximately 125 kHz), the coils Sᵢ, which are disposed perpendicularly with respect to one another are preferably used as the antenna unit 6. FIGS. 2A to 2C each show exemplary embodiments of such an antenna unit 6. Because each coil Sₓ, S_{y}, S_{z} generates in itself a linearly polarized field, two coils Sₓ, S_{y}, S_{z} which are perpendicular to one another at a location generate two electromagnetic fields which are perpendicular to one another and whose field vectors are perpendicular to one another. The two electromagnetic fields, which are generated, are superimposed to form a single superimposed field.

If the coils Sₓ, S_{y}, S_{z} are then actuated shifted with respect to one another by a phase angle of less than or equal to 90° (and greater than 0°), an elliptically polarized field is generated as the superimposed field, and in a special case with a phase angle of precisely 90°—a field having circular polarization is generated.

The coils Sₓ, S_{y}, S_{z} are preferably wound on a ferrite core 11 so that the dimensions of the antenna unit 6 do not become too large and the antennas can be actuated with less energy. In FIGS. 2A and 2B, a cross shaped ferrite core 11 is provided on which the coils Sₓ and S_{y} are wound diagonally in crisscross fashion and perpendicularly to one another. They are thus wound in such a way that a magnetic flux vector φ which is generated in each axial direction when a current flows through a coil Sₓ, S_{y}, S_{z} lies perpendicularly on the flux vector φ of the other coil Sₓ, S_{y}, S_{z}. FIG. 2C illustrates two ferrite cores 11 on which in each case the coil Sₓ and S_{y} is wound. The two ferrite cores 11 are disposed perpendicularly with respect to one another so that the flux vectors φ, and thus the field vectors, are also perpendicular with respect to one another.

So that the portable code transmitter 2 (FIG. 3) can detect the wave having elliptical or circular polarization as such, and can also receive it correspondingly, it has at least two antennas 21, 22 or 23 which can each independently detect a respective field component of the emitted electromagnetic field. Because the code transmitter 2 is carried by the user, its direction of orientation is initially irrelevant. For the wave having elliptical or circular polarization to be reliably received, at least three antennas 21, 22, 23, which are oriented in different spatial directions should be present. What is referred to as a three-dimensional code transmitter 2 (3D code transmitter), such as is known for example from the Published, Non-Prosecuted German Patent Application DE 197 18 423 A1, is used.

The code transmitter 2 has the first antenna 21 with a coil Aₓ, which can detect a magnetic flux φₓ in the x direction, the second antenna 22 with a coil A_{y} which can detect a magnetic flux φ_{y} in the y direction and the third antenna 23 with a coil A_{z} which can detect a magnetic flux φ_{z} in the z direction.

The coils Aₓ, A_{y}, A_{z} are connected to a transceiver unit 24 and to a control and evaluation unit 25 on the code transmitter 2. The field components, detected by the coils Aₓ, A_{y}, A_{z}, of the various spatial directions are evaluated in terms of the field strength in the control and evaluation unit 25. If a wave having elliptical or circular polarization is emitted, a field is detected in at least two of the coils Aₓ, A_{y} or A_{z} when a signal is received (i.e. a voltage which is proportional to the field strength is induced in the respective coil Aₓ, A_{y}, A_{z} owing to a magnetic flux φ). If a field is detected by only one of the coils Aₓ, A_{y}, A_{z}, no wave having elliptical or circular polarization has been received. So that the two antennas 21 and 22 can receive as sensitively as possible in the x and y directions (with the smallest possible overall size), the coils Aₓ and A_{y} are wound around highly permeable ferrite cores 26. On the other hand, the coil A_{z} extends as an air coil (conductor track coil of a printed circuit board 27 of the code transmitter 2) over part of the code transmitter 2 or preferably around the entire circumference of the printed circuit board 27 of the code transmitter 2. However, for the invention it is not significant whether the coils Aₓ, A_{y}, A_{z} are embodied as ferrite coils or air coils but only that they are sensitive in different spatial directions and detect the corresponding field components in terms of the field strength in the respective direction.

Only if the code transmitter 2 receives a wave having elliptical or circular polarization, i.e. if in each case a corresponding voltage is induced in the coils Aₓ, A_{y} or A_{z} by a magnetic flux φ which is present at least in two field directions, it generates itself from a coded information item a response signal which is transmitted back to the vehicle. Because the code transmitter 2 automatically generates a response signal after reception of the interrogation signal and transmits it back, it is also referred to as a transponder.

To be on the safe side, the phase between the induced voltages in the various coils Aₓ, A_{y}, A_{z} can also be measured. If this phase corresponds to the transmitted phase shift, the interrogation signal is accepted.

It is also possible to provide that the code transmitter 2 emits a response signal in all cases if it receives an interrogation signal. In the response signal, it then informs the transceiver unit 1 in the motor vehicle whether it has detected a field having elliptical or circular polarization. As a function of this, the control and evaluation unit 3 then accepts the response signal, or does not accept it.

It is also possible to provide that the code transmitter 2 itself emits its response signal in a wave having elliptical or circular polarization. The coded information item is then evaluated in the transceiver unit 1 in the motor vehicle only if a spatial field having at least two field directions is received there. If, in addition, the received coded information item then also corresponds to the expected desired code information item, the desired, vehicle-specific functions are controlled or the corresponding settings made.

With the anti-theft system according to the invention anyone wishing to monitor the transmitted signals without permission and without being noticed has to have a complex receiver and, if appropriate, a complex transmitter to be able to reproduce the signals appropriately.

In order to increase protection against undesired criminal monitoring further, it is possible to provide that the coil Sₓ, S_{y}, S_{z} is actuated in one field direction for a short time period with a changed transmission power (the amplitude is changed with respect to the previous amplitude). As a result, the field strength of a field component becomes temporarily larger or smaller within the signal.

Starting from a time t₁, according to FIG. 4A the amplitude of the field is temporarily increased in the x direction (the signal which is phase-shifted by 90° in the y direction is illustrated in FIG. 4B) . After the period Δt₀ (i.e. at the time t₂), the transmission is carried out again with a normal field strength. The code generator 2 transmits a response signal back only if it then also receives an increased amplitude/field strength in one field direction at the time t₁ within only transmitted signal and for the time period Δt₀.

Instead of changing the amplitude, the time t₁ can also be shifted within the entire signal duration or the time period Δt₀ can be changed. The receiver 5 or the transceiver unit 24 and the associated control and evaluation unit 3 or 25 must only know the corresponding settings/pre-specified values of the field strength, time points t and time periods Δt. These pre-specified values are not public and are peculiar to each anti-theft system. The authorization of the actual coded information item is checked only if a changed amplitude is detected at a predetermined time t₁ and for a predetermined time period Δt₀ at the receive end, or if a changed time t₁ and/or a changed time period Δt₀ corresponding to the expected pre-specified values are detected. Otherwise, the received signal is not accepted.

The changing of the amplitude, of the time t₁ or of the time period Δt₀ constitutes an additional coding operation, which cannot be easily picked up by an unauthorized monitoring party. Instead of a fixed change in these pre-specified values, a variable change can also be performed whenever a signal is emitted, as a function of the time of day, for example.

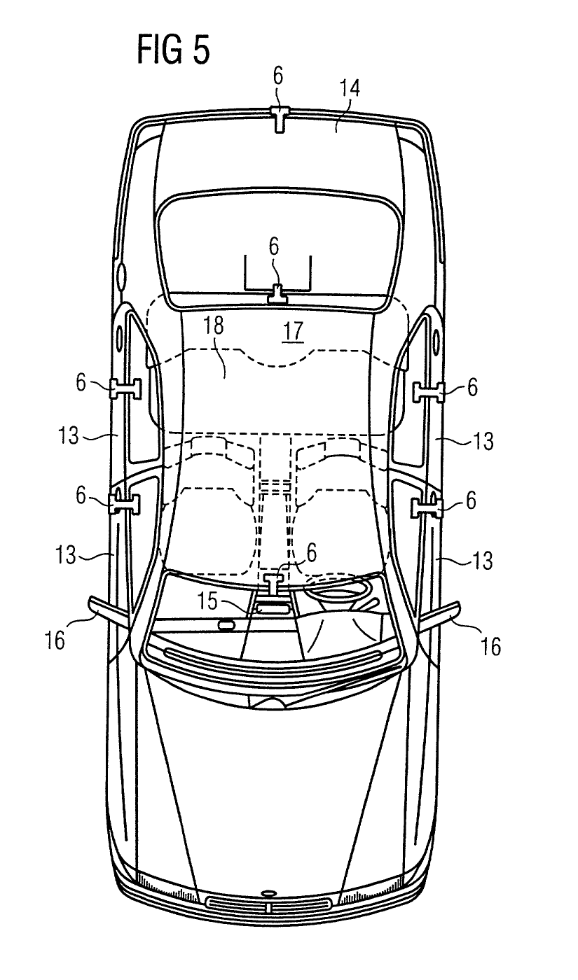

The antenna units 6 in the motor vehicle are preferably disposed on the bodywork of the motor vehicle in accordance with FIG. 5. For example, the antenna units 6 can be disposed in all doors 13 and a rear lid 14, i.e. in the door of the driver, a door of the front seat passenger or also in the rear doors. Likewise, it is possible to dispose the antenna unit 6 in a region of an interior mirror 15 and/or of an external mirror 16, respectively. So that the rear lid 14 can also be unlocked and opened, the antenna units 6 are disposed on the outside of the rear lid 14 and/or in a region of a rear parcel shelf 17 or a rear bench seat 18.

Because the metal bodywork with the metal paneling (bodywork sheet metal) attenuates electromagnetic fields to a greater or lesser extent, the antenna units 6 for the exterior are preferably disposed on the outside of the bodywork and the antenna units 6 for the interior are preferably disposed on the inside of the bodywork. In this way, the entire space in and in the vicinity around the motor vehicle is covered “in terms of signaling”. If the code transmitter 2 is then located in the vicinity outside the motor vehicle or in the motor vehicle, it can receive the interrogation signals of the transceiver unit mounted on the motor vehicle and respond to them. In this way, all the desired functions can be remote-controlled from the inside or the outside.

Because the signals are emitted as waves having the elliptical or circular polarization and the waves having the elliptical or circular polarization are detected as such, the signals transmitted in such an anti-theft system can be monitored, but correctly reproduced only at great cost.

I claim:

1. An anti-theft system for a motor vehicle, comprising:
a vehicle-mounted transceiver unit for emitting an interrogation signal, said transceiver unit having an antenna unit emitting a wave having one of an elliptical polarization and a circular polarization and the wave includes the interrogation signal;
a portable code transmitter transmitting back a response signal if said code transmitter receives the interrogation signal; and
a vehicle-mounted evaluation unit receiving and checking an authorization of the response signal and if the response signal provides proper authorization, said evaluation unit one of triggers and enables vehicle-specific functions.

2. The anti-theft system according to claim 1, wherein at least one of said transceiver unit and said code transmitter has at least two antennas disposed approximately perpendicularly to one another and are controlled phase-shifted with respect to one another for a transmission of signals in order to generate the wave.

3. The anti-theft system according to claim 1, wherein the vehicle-specific functions include a locking of locks, an unlocking of the locks, a turning-off of an immobilizer, and a turning-on of the immobilizer, and the vehicle-specific functions are controlled by the response signal generated by said code transmitter.

4. A method for operating an anti-theft system, which comprises the steps of:
using a vehicle-mounted transceiver unit for emitting an interrogation signal provided in a wave having one of an elliptical polarization and a circular polarization;
receiving the interrogation signal in a portable code transmitter; and
transmitting back a response signal by the code transmitter only if at least two field components of the interrogation signal which are different in their spatial direction are received.

5. The method according to claim 4, which comprises generating the wave using two coils disposed perpendicularly with respect to one another, the two coils functioning as antennas and are actuated by a phase angle of less than/equal to 90° with respect to one another.

6. The method according to claim 5, which comprises actuating one of the two antennas for at least a predetermined time period starting at a predetermined time with a modified transmission power.

7. A method for operating an anti-theft system, which comprises the steps of:
receiving an interrogation signal in a portable code transmitter and a response signal is subsequently transmitted back as a wave having one of an elliptical polarization and a circular polarization; and
recognizing the response signal as being authorized by a vehicle-mounted transceiver unit only if, at least two field components of the response signal which are different in their spatial direction are received and, a coded information item contained in the response signal corresponds to a coded information item expected by a vehicle-mounted evaluation unit.

8. The method according to claim 7, which comprises generating the wave using two coils disposed perpendicularly with respect to one another, the two coils functioning as antennas and are actuated by a phase angle of less than/equal to 90° with respect to one another.

9. The method according to claim 8, which comprises actuating one of the two antennas for at least a predetermined time period starting at a predetermined time with a modified transmission power.
